(19) United States
(12) Patent Application Publication
(10) Pub. No.: US 2002/0004722 A1
(43) Pub. Date: Jan. 10, 2002

(54) Voice speed converting apparatus

(76) Inventor: Takeo Inoue, Osaka (JP)

Correspondence Address: SMITH, GAMBRELL & RUSSELL, LLP, Suite 800, 1850 M Street, N.W., Washington, DC, 20036, US

(21) Appl. No.: 09/793,409

(22) Filed: Feb. 27, 2001

(30) Foreign Application Priority Data
Feb. 28, 2000 (JP) 2000-051305

(51) Int. Cl. G10L 21/00; G10L 19/00

(52) U.S. Cl. 704/500

(57) ABSTRACT

In a voice speed converting apparatus comprising voice speed conversion processing means for subjecting an input audio signal inputted from an audio reproducer to voice speed conversion processing, an audio data storing memory into which an output of the voice speed conversion processing means is to be written, and means for reading out audio data from the audio data storing memory, a voice speed converting apparatus comprises calculation means for calculating the storage ratio of the audio data, which have not been read out yet, in the audio data storing memory, and control means for controlling the reproduction speed of the audio reproducer depending on the storage ratio of the audio data, which have not been read out yet, in the audio data storing memory.

### BACKGROUND OF THE INVENTION

1. Field of the Invention

The present invention relates to a voice speed converting apparatus.

2. Description of the Prior Art

At the time of high speed reproduction by a VTR (Video Tape Recorder), a voice speed converting apparatus for deleting audio signals in a silence section out of audio signals read from a video tape, compressing the audio signals in a voice section on the time axis by a time axis compressor/expander, and outputting a voice in the voice section at a speed lower than the reproduction speed of the VTR which is set by a user (the set reproduction speed) has been known (see JP-A-7-192392).

In such a voice speed converting apparatus, there is provided a ring memory (an audio data storing memory) for absorbing, in outputting an input voice with the voice speed thereof reduced, a time delay which occurs between the input voice and an output voice. When the amount of storage of the audio data, which have not been read out yet, in the ring memory exceeds the capacity of the ring memory, the output voice is broken.

In order that the amount of storage of the audio data, which have not been read out yet, in the ring memory does not exceed the capacity of the ring memory, therefore, the compression ratio in the time axis compressor/expander is changed when the amount of storage of the audio data, which have not been read yet, in the ring memory exceeds a predetermined amount. However, this causes the voice speed of the output voice to be increased.

Furthermore, a voice speed converting apparatus for reducing the voice speed of a voice outputted from an audio reproducer such as a tape recorder in order to aid the aged, for example, in hearing or to learn languages has been put to practical use. Also in this case, however, the same problem arises.

### SUMMARY OF THE INVENTION

An object of the present invention is to provide a voice speed converting apparatus capable of preventing the amount of storage of audio data, which have not been read out yet, in an audio data storing memory from exceeding the capacity of the audio data storing memory without making the voice speed of an output voice very high even when the amount of storage of the audio data, which have not been read out yet, in the audio data storing memory is increased.

In a voice speed converting apparatus comprising voice speed conversion processing means for subjecting an input audio signal inputted from an audio reproducer to voice speed conversion processing, an audio data storing memory into which an output of the voice speed conversion processing means is to be written, and means for reading out audio data from the audio data storing memory, a first voice speed converting apparatus according to the present invention is characterized by comprising calculation means for calculating the storage ratio of the audio data, which have not been read out yet, in the audio data storing memory; and control means for controlling the reproduction speed of the audio reproducer depending on the storage ratio of the audio data, which have not been read out yet, in the audio data storing memory.

An example of the voice speed conversion processing means is one comprising section judgment means for judging whether the input audio signal corresponds to a voice section or a silence section; deletion processing means for deleting the input audio signal which is judged to correspond to the silence section; and time axis compression/expansion processing means for subjecting the input audio signal which is judged to correspond to the voice section to time axis compression/expansion processing at a compression ratio corresponding to the storage ratio of the audio data, which have not been read out yet, in the audio data storing memory.

Examples of the audio reproducer include a VTR and hard disk recorder.

In a voice speed converting apparatus comprising analog-to-digital conversion means for sampling an analog audio signal inputted from an audio reproducer at a sampling frequency corresponding to the set reproduction speed magnification, a frame memory into which the audio data outputted from the analog-to-digital conversion means is to be inputted, voice speed conversion processing means for subjecting, every time a required number of audio data are inputted to the frame memory, the audio data to voice speed conversion processing, an audio data storing memory into which an output of the voice speed conversion processing means is to be written, and means for reading out the audio data from the audio data storing memory, a second voice speed converting apparatus according to the present invention is characterized by comprising calculation means for calculating the storage ratio of the audio data, which have not been read out yet, in the audio data storing memory; and control means for controlling the reproduction speed of the audio reproducer depending on the storage ratio of the audio data, which have not been read out yet, in the audio data storing memory.

In a voice speed converting apparatus comprising a frame memory into which a digital audio signal inputted from an audio reproducer is to be written at a speed corresponding to the set reproduction speed magnification, voice speed conversion processing means for subjecting, every time a required number of audio data are inputted to the frame memory, the audio data to voice speed conversion processing, an audio data storing memory into which an output of the voice speed conversion processing means is to be written, and means for reading out the audio data from the audio data storing memory, a third voice speed converting apparatus is characterized by comprising calculation means for calculating the storage ratio of the audio data, which have not been read out yet, in the audio data storing memory; and control means for controlling the reproduction speed of the audio reproducer depending on the storage ratio of the audio data, which have not been read out yet, in the audio data storing memory.

An example of the voice speed conversion processing means in the second or third voice speed converting apparatus is one comprising section judgment means for judging whether an input voice composed of a required number of audio data inputted to the frame memory corresponds to a voice section or a silence section; deletion processing means for deleting the audio data which is judged to correspond to the silence section; and time axis compression/expansion processing means for subjecting the audio data which is judged to correspond to the voice section to time axis compression/expansion processing at a compression ratio corresponding to the storage ratio of the audio data, which have not been read out yet, in the audio data storing memory.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a voice speed converting apparatus according to a first embodiment;

FIG. 2 is a block diagram showing a modified example of the first embodiment;

FIG. 3 is a block diagram showing the configuration of a voice speed converting apparatus according to a second embodiment; and

FIG. 4 is a block diagram showing the configuration of a voice speed converting apparatus according to a third embodiment.

### DETAILED DESCRIPTION OF THE PREFERRED EMBODIMENTS

Referring now to the drawings, embodiments of the present invention will be described.

[1] Description of First Embodiment

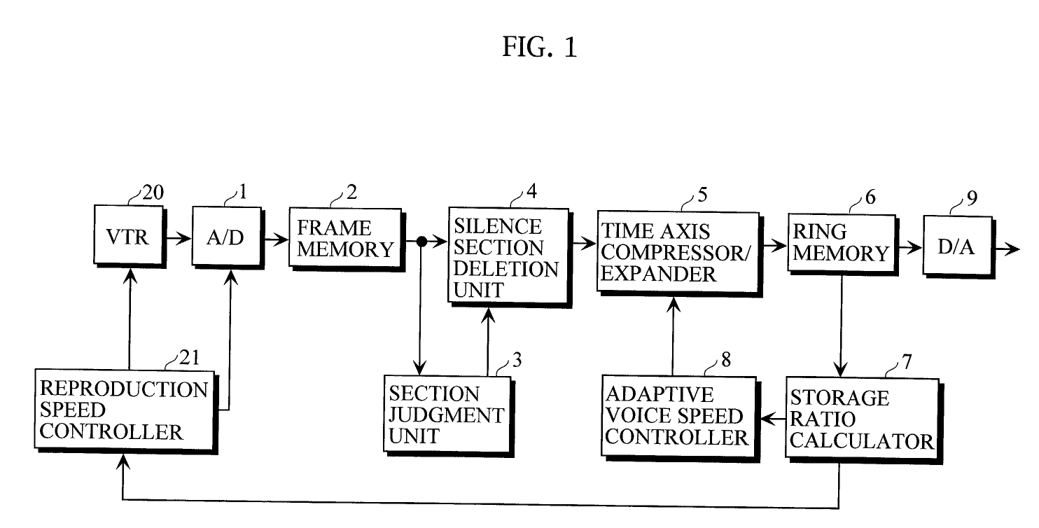

FIG. 1 illustrates the configuration of a voice speed converting apparatus for outputting, at the time of reproduction by a VTR 20, a voice at a speed lower than the reproduction speed of the VTR 20 which is set by a user (the set reproduction speed). A video signal outputted from the VTR is displayed on a monitor (not shown), which is not illustrated in FIG. 1.

An audio signal outputted from the VTR 20 is fed to an analog-to-digital (A/D) converter 1, where the fed audio signal is converted into a digital signal composed of 12 bits, for example.

An output of the A/D converter 1 is stored once in a frame memory 2. A section judgment unit 3, a silence section deletion section 4, and a time axis compressor/expander 5 perform processing with respect to audio data for frame which are stored in the frame memory 2.

The section judgment unit 3 judges whether an input voice corresponds to a voice section or a silence section on the basis of the average value of the powers, the accumulated value of the powers, the average value of the amplitudes, the accumulated value of the amplitudes, and so forth, of audio data corresponding to one frame. The silence section deletion unit 4 deletes the audio data which are judged to correspond to the silence section by the section judgment unit 3. The audio data other than the audio data corresponding to the silence section which have been deleted by the silence section deletion unit 4 (the audio data corresponding to the voice section) are fed to the time axis compressor/expander 5, where the fed audio data are subjected to time axis compression/expansion processing.

The audio data which have been subjected to the time axis compression/expansion processing by the time axis compressor/expander 5 are stored once in a ring memory 6 (an audio data storing memory). The audio data stored in the ring memory 6 are read out, and are fed to a digital-to-analog (D/A) converter 9, where the fed audio data are converted into analog signals. The analog signals are outputted at a predetermined speed.

The storage ratio of the audio data, which have not been read out yet, in the ring memory 6 is calculated by a storage ratio calculator 7. The storage ratio of the audio data, which have not been read yet, in the ring memory 6 means the ratio [%] of the amount of storage of the audio data, which have not been read out yet, to the total amount of the audio data which can be stored in the ring memory 6. The storage ratio calculated by the storage ratio calculator 7 is fed to an adaptive voice speed controller 8, and is fed to a reproduction speed controller 21 for controlling the reproduction speed of the VTR 20.

In the following description, the compression ratio is defined as P/Q, letting P be the time length of a signal (the number of data) inputted to the time axis compressor/expander 5, and Q be the time length of a signal (the number of data) outputted from the time axis compressor/expander 5 with respect to the inputted signal. The storage ratio of the audio data, which have not been read out yet, in the ring memory 6 shall be merely referred to as a storage ratio.

The adaptive voice speed controller 8 controls the compression ratio used in the time axis compressor/expander 5 on the basis of the storage ratio. Further, the reproduction speed controller 21 controls the actual reproduction speed (the actual reproduction speed magnification) of the VTR 20 on the basis of the reproduction speed magnification of the VTR 20 set by the user (hereinafter referred to as the set reproduction speed magnification) and the storage ratio.

The standard sampling frequency of the A/D converter 1 and the standard sampling frequency of the D/A converter 9 are 8 kHz in this example. When the reproduction speed magnification of the VTR 20 is M, the sampling frequency f_{AD} of the A/D converter 1 is set to M times the sampling frequency f_{DA} of the D/A converter 9 in order that sampling data obtained by the A/D converter 1 at the time of reproduction at a speed which is M times a standard reproduction speed (a reproduction speed at a reproduction speed magnification of 1) and sampling data obtained by the A/D converter 1 at the time of reproduction at the standard reproduction speed coincide with each other. In the case of M=2 (at the time of reproduction at twice the standard reproduction speed), f_{AD}=16 kHz and f_{DA}=8 kHz. The sampling frequency f_{DA} of the D/A converter 9 is always maintained at the standard sampling frequency (8 kHz) irrespective of the reproduction speed magnification.

Description is made of the operations of the adaptive voice speed controller 8 and the reproduction speed controller 21 in a case where a voice is outputted at a speed lower than the set reproduction speed at the time of reproduction at twice the standard reproduction speed.

Table 1 shows the relationship between the storage ratio and the compression ratio and the relationship between the storage ratio and the reproduction speed magnification in a case where the set reproduction speed magnification is 2. In Table 1, the memory remaining ratio is a value obtained by subtracting the storage ratio [%] from 100.

TABLE 1

| Storage ratio | | Reproduction |
|---|---|---|
| (memory | Compression | speed |
| remaining ratio) | ratio | magnification |
| 0˜20% (80˜ | 1 | 2 |
| 100) | | |
| 20˜40% (60˜80) | 1.2 | 2 |
| 40˜60% (40˜60) | 1.4 | 2 |
| 60˜80% (20˜40) | 1.4 | 1.8 |
| 80˜95% (5˜20) | 1.4 | 1.6 |
| 95˜100% (0˜5) | 1.4 | 1.4 |

The adaptive voice speed controller 8 comprises a storage ratio/compression ratio table storing the relationship between the storage ratio and the compression ratio in Table 1. The reproduction speed controller 21 comprises a storage ratio/reproduction speed magnification table storing the relationship between the storage ratio and the reproduction speed magnification in Table 1.

The adaptive voice speed controller 8 reads out, when the storage ratio is fed from the storage ratio calculator 7, the compression ratio corresponding to the storage ratio fed from the storage ratio calculator 7 on the basis of the storage ratio/compression ratio table, and sets the read compression ratio in the time axis compressor/expander 5. The reproduction speed controller 21 reads out, when the storage ratio is fed from the storage ratio calculator 7, the reproduction speed magnification corresponding to the storage ratio fed form the storage ratio calculator 7 on the basis of the storage ratio/reproduction speed magnification table, to carry out control such that the reproduction speed of the VTR 20 corresponds to the read reproduction speed magnification.

(1) When the storage ratio is 0 to 20% (not less than 0 and less than 20%)

When the storage ratio is 0 to 20%, the compression ratio is set to 1, and the reproduction speed magnification is set to 2 which is the set reproduction speed magnification. In this case, the audio signal outputted from the VTR 20 at a reproduction speed corresponding to the set reproduction speed magnification 2 is sampled by the A/D converter 1 at a frequency (16 kHz) which is twice the standard sampling frequency of the D/A converter 9, and is stored in the frame memory 2.

Out of the audio data stored in the frame memory 2, the audio data corresponding to the silence section are deleted by the silence section deletion unit 4, and the audio data other than the deleted audio data are then stored in the ring memory 6 without being subjected to time axis compression/expansion processing by the time axis compressor/expander 5 The audio data stored in the ring memory 6 are sampled at the standard sampling frequency (8 kHz) by the D/A converter 9, and are outputted. Consequently, the voice speed of an output voice is equal to that at the time of reproduction at the standard reproduction speed.

Since the rate of data transfer in writing to the ring memory 6 is higher than the rate of data transfer in reading from the ring memory 6, the amount of storage of the audio data, which have not been read out yet, in the ring memory 6 is increased. The smaller the number of the audio data corresponding to the silence section out of the input audio data is, the higher the speed at which the amount of storage of the audio data which have not been read out yet is increased becomes.

(2) When the storage ratio is 20 to 40%

When the storage ratio is 20 to 40%, the compression ratio is set to 1.2. However, the reproduction speed magnification remains at 2. In this case, the time axis compressor/expander 5 subjects the input audio data to time axis compression processing such that the ratio of the time length P of an input signal to the time length Q of an output signal is 1.2:1. As a result, the voice speed of an output voice is slightly higher than that at the time of reproduction at the standard reproduction speed. On the other hand, the number of the audio data corresponding to the voice section which are inputted to the ring memory 6 is reduced. Accordingly, the ratio of the number of data written into the ring memory 6 to the number of data read out of the ring memory 6 can be made lower, as compared with that in the above-mentioned case (1)

(3) When the storage ratio is 40 to 60%

When the storage ratio is 40 to 60%, the compression ratio is set to 1.4. However, the reproduction speed magnification remains at 2. In this case, the time axis compressor/expander 5 subjects the input audio data to time axis compression processing such that the ratio of the time length P of an input signal to the time length Q of an output signal is 1.4:1. As a result, the voice speed of an output voice is further made higher, as compared with that in the above-mentioned case (2). On the other hand, the number of the audio data corresponding to the voice section which are inputted to the ring memory 6 is further made smaller, as compared with that in the above-mentioned case (2). Accordingly, the ratio of the number of data written into the ring memory 6 to the number of data read out of the ring memory 6 can be made lower, as compared with that in the above-mentioned case (2).

(4) When the storage ratio is 60 to 80%

When the storage ratio is 60 to 80%, the compression ratio is set to 1.4, and the reproduction speed magnification is set to 1.8. In this case, the sampling frequency f_{AD} of the A/D converter 1 is set to 1.8 times the standard sampling frequency f_{DA} of the D/A converter 9. The time axis compressor/expander 5 subjects the input audio data to time axis compression processing such that the ratio of the time length P of an input signal to the time length Q of an output signal is 1.4:1. Further, the reproduction speed controller 21 carries out control such that the reproduction speed of the VTR 20 corresponds to the reproduction speed magnification 1.8.

Since the reproduction speed magnification is set to 1.8, the rate of data transfer in writing to the ring memory 6 is made lower, as compared with that in the above-mentioned case (3). Accordingly, the ratio of the number of data written into the ring memory 6 to the number of data read out of the ring memory 6 can be made lower, as compared with that in the above-mentioned case (3).

(5) When the storage ratio is 80 to 95%

When the storage ratio is 80 to 95%, the compression ratio is set to 1.4, and the reproduction speed magnification is set to 1.6. In this case, the sampling frequency f_{AD} of the A/D converter 1 is set to 1.6 times the standard sampling frequency f_{DA} of the D/A converter 9. The time axis compressor/expander 5 subjects the input audio data to time axis compression processing such that the ratio of the time length P of an input signal to the time length Q of an output signal is 1.6:1. Further, the reproduction speed controller 21 carries out control such that the reproduction speed of the VTR 20 corresponds to the reproduction speed magnification 1.6.

Since the reproduction speed magnification is s set to 1.6, the rate of data transfer in writing to the ring memory 6 is made lower, as compared with that in the above-mentioned case (4). Accordingly, the ratio of the number of data written into the ring memory 6 to the number of data read out of the ring memory 6 can be made lower, as compared with that in the above-mentioned case (4).

(6) When the storage ratio is 95 to 100%

When the storage ratio is 95 to 100%, the compression ratio is set to 1.4, and the reproduction speed magnification is set to 1.4. In this case, the sampling frequency f_{AD} of the A/D converter 1 is set to 1.4 times the standard sampling frequency f_{DA} of the D/A converter 9. The time axis compressor/expander 5 subjects the input audio data to time axis compression processing such that the ratio of the time length P of an input signal to the time length Q of an output signal is 1.4:1. Further, the reproduction speed controller 21 carries out control such that the reproduction speed of the VTR 20 corresponds to the reproduction speed magnification 1.4.

Since the reproduction speed magnification is set to 1.4, the rate of data transfer in writing to the ring memory 6 is made lower, as compared with that in the above-mentioned case (5). Accordingly, the ratio of the number of data written into the ring memory 6 to the number of data read out of the ring memory 6 can be made lower, as compared with that in the above-mentioned case (5).

When the storage ratio of the audio data which have not been read out yet is low, for example, when the storage ratio of the audio data which have not been read out yet is less than 20%, a deletion operation performed by the silence section deletion unit 4 may be stopped.

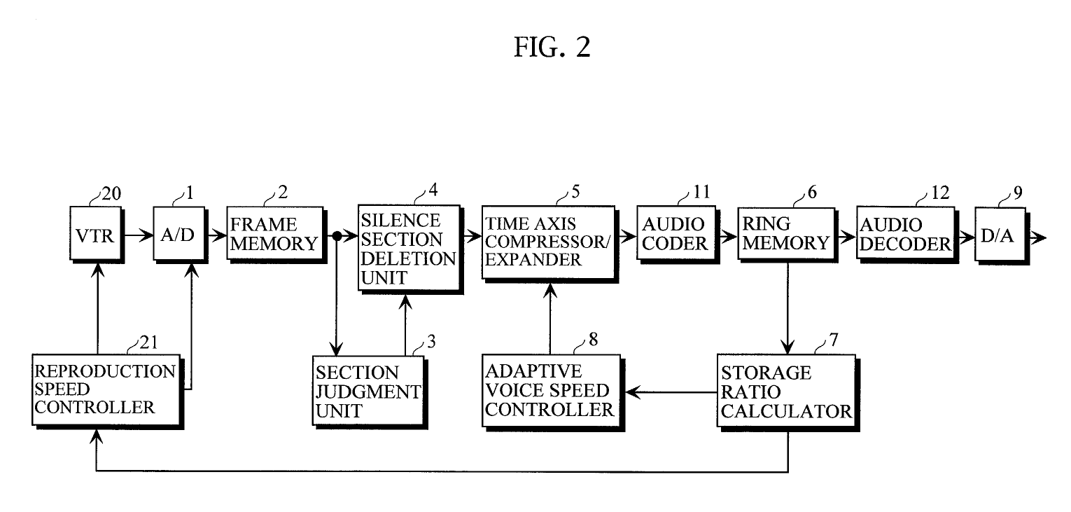

When it is desired to use as the ring memory 6 one having a smaller capacity, an audio coder 11 for coding the audio data outputted from the time axis compressor/expander 5 may be provided in the preceding stage of the ring memory 6, and an audio decoder 12 for decoding the coded audio data read out of the ring memory 6 may be provided in the succeeding stage of the ring memory 6, as shown in FIG. 2.

[2] Description of Second Embodiment

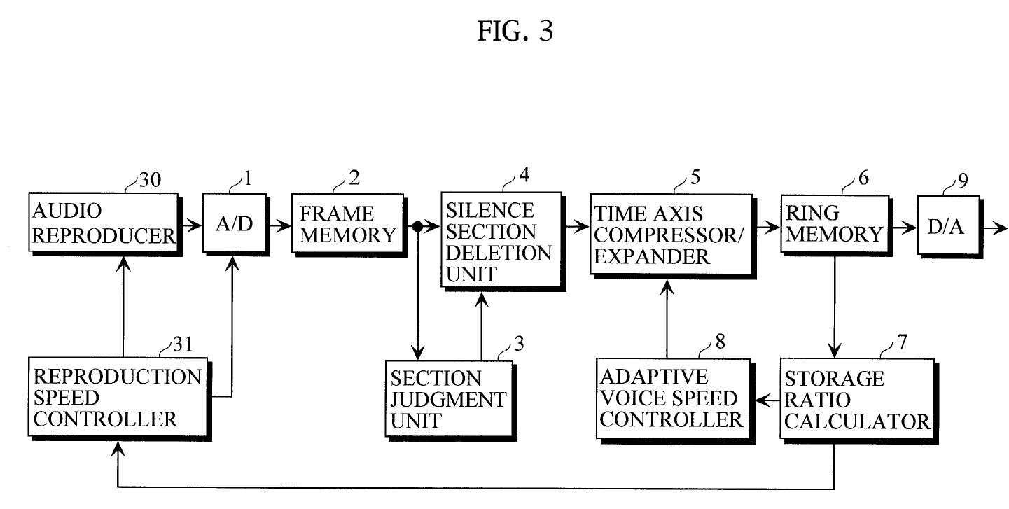

FIG. 3 illustrates the configuration of a voice speed converting apparatus for outputting a voice at a speed lower than a standard reproduction speed in an audio reproducer such as a tape recorder. In FIG. 3 the same units as those shown in FIG. 1 are assigned the same reference numerals and hence, the description thereof is not repeated.

In FIG. 3 reference numeral 30 denotes an audio reproducer, and 31 denotes a reproduction speed controller of the audio reproducer 30.

When the reproduction speed magnification of the audio reproducer 30 is M, the sampling frequency f_{AD} of an A/D converter 1 is set to M times the sampling frequency f_{DA} of a D/A converter 9 in order that sampling data obtained by the A/D converter 1 at the time of reproduction at a speed which is M times the standard reproduction speed and sampling data obtained by the A/D converter 1 at the time of reproduction at the standard reproduction speed coincide with each other. The sampling frequency f_{DA} of the D/A converter 9 is always maintained at a standard sampling frequency irrespective of the reproduction speed magnification.

Description is made of the operations of an adaptive voice speed controller 8 and the reproduction speed controller 31 in a case where a voice is outputted at a speed lower than the standard reproduction speed at the time of reproduction at the standard reproduction speed.

Table 2 shows the relationship between the storage ratio and the compression ratio and the relationship between the storage ratio and the reproduction speed magnification in a case where the set reproduction speed magnification is 1.

TABLE 2

| Storage ratio | | Reproduction |
|---|---|---|
| (memory | Compression | speed |
| remaining ratio) | ratio | magnification |
| 0˜25% (75˜ | 0.7 | 1 |
| 100) | | |
| 25˜50% (50˜75) | 0.8 | 1 |
| 50˜75% (25˜50) | 0.9 | 0.9 |
| 75˜100% (0˜25) | 1 | 0.8 |

The adaptive voice speed controller 8 comprises a storage ratio/compression ratio table storing the relationship between the storage ratio and the compression ratio in Table 2. The reproduction speed controller 31 comprises a storage ratio/reproduction speed magnification table storing the relationship between the storage ratio and the reproduction speed magnification in Table 2.

The adaptive voice speed controller 8 reads out, when the storage ratio of audio data which have not been read out yet is fed from a storage amount calculator 7, the compression ratio corresponding to the storage ratio fed from the storage ratio calculator 7 on the basis of the storage ratio/compression ratio table, and sets the read compression ratio in the time axis compressor/expander 5. The reproduction speed controller 21 reads out, when the storage ratio of the audio data which have not been read out yet is fed from the storage ratio calculator 7, the reproduction speed magnification corresponding to the storage ratio fed form the storage ratio calculator 7 on the basis of the storage ratio/reproduction speed magnification table, to carry out control such that the reproduction speed of the audio reproducer 30 corresponds to the read reproduction speed magnification.

(1) When the storage ratio is 0 to 25%

When the storage ratio is 0 to 25%, the compression ratio is set to 0.7, and the reproduction speed magnification is set to 1 which is the set reproduction speed magnification. In this case, an audio signal outputted from the audio reproducer 30 at a reproduction speed corresponding to the set reproduction speed magnification 1 is sampled by the A/D converter 1 at the same sampling frequency as the standard sampling frequency of a D/A converter 9, and is stored in a frame memory 2.

Out of the audio data stored in the frame memory 2, the audio data corresponding to a silence section are deleted by a silence section deletion unit 4, and the audio data other than the deleted audio data are then fed to the time axis compressor/expander 5. The time axis compressor/expander 5 subjects the input data (the audio data corresponding to a voice section) to time axis expansion processing such that the ratio of the time length P of an input signal to the time length Q of an output signal is 0.7:1.

The audio data which have been subjected to the time axis expansion processing by the time axis compressor/expander 5 are stored in a ring memory 6. The audio data stored in the ring memory 6 are sampled at the standard sampling frequency by the D/A converter 9, and are outputted.

The audio data corresponding to the voice section are expanded on the time axis, and are written into the ring memory 6. Accordingly, the voice speed of an output voice is lower than that at the time of reproduction at the standard reproduction speed. However, the smaller the number of the audio data corresponding to the silence section is, the larger the amount of storage of the audio data, which have not been read out yet, in the ring memory 6 becomes.

(2) When the storage ratio is 25 to 50%

When the storage ratio is 25 to 50%, the compression ratio is set to 0.8. However, the reproduction speed magnification remains at 1. In this case, the time axis compressor/expander 5 subjects the input audio data to time axis expansion processing such that the ratio of the time length P of an input signal to the time length Q of an output signal is 0.8:1. As a result, the voice speed of an output voice is lower than that at the time of reproduction at the standard reproduction speed, but is slightly higher, as compared with that in the above-mentioned case (1). However, the number of the audio data corresponding to the voice section which are inputted to the ring memory 6 is made smaller, as compared with that in the above-mentioned case (1). Accordingly, the ratio of the number of data written into the ring memory 6 to the number of data read out of the ring memory 6 can be made lower, as compared with that in the above-mentioned case (1).

(3) When the storage ratio is 50 to 75%

When the storage ratio is 50 to 75%, the compression ratio is set to 0.9, and the reproduction speed magnification is set to 0.9. In this case, the sampling frequency f_{AD} of the A/D converter 1 is set to 0.9 times the standard sampling frequency f_{DA} of the D/A converter 9.

The time axis compressor/expander 5 subjects the input audio data to time axis expansion processing such that the ratio of the number of data P inputted per unit time to the number of data Q outputted per unit time is 0.9:1. Further, the reproduction speed controller 31 carries out control such that the reproduction speed of the audio reproducer 30 corresponds to the reproduction speed magnification 0.9.

Since the compression ratio on the time axis is made higher, as compared than that in the above-mentioned case (2), and the reproduction speed magnification is made lower, as compared with that in the above-mentioned case (2), the ratio of the number of data written into the ring memory 6 to the number of data read out of the ring memory 6 can be made lower, as compared with that in the above-mentioned case (2). However, the reproduction speed magnification is made lower, as compared with that in the above-mentioned case (2). Accordingly, the voice speed of an output voice is not made higher, as compared with that in a case where only the compression ratio is increased.

(4) When the storage ratio is 75 to 100%

When the storage ratio is 75 to 100%, the compression ratio is set to 1.0, and the reproduction speed magnification is set to 0.8. In this case, the sampling frequency f_{AD} of the A/D converter 1 is set to 0.8 times the standard sampling frequency f_{DA} of the D/A converter 9.

The time axis compressor/expander 5 does not perform time axis expansion processing. The reproduction speed controller 31 carries out control such that the reproduction speed of the audio reproduce 30 corresponds to the reproduction speed magnification 0.8.

Since the compression ratio on the time axis is made higher, as compared with that in the above-mentioned case (3), and the reproduction speed magnification is made lower, as compared with that in the above-mentioned case (3), the ratio of the number of data written into the ring memory 6 to the number of data read out of the ring memory 6 can be made lower, as compared with that in the above-mentioned case (3). However, the reproduction speed magnification is made lower, as compared with that in the above-mentioned case (3). Accordingly, the voice speed of an output voice is not made higher, as compared with that in a case where only the compression ratio is increased.

When the storage ratio of the audio data which have not been read out yet is low, for example, when the storage ratio of the audio data which have not been read out yet is less than 20%, a deletion operation performed by the silence section deletion unit 4 may be stopped.

When it is desired to use as the ring memory 6 one having a smaller capacity, an audio coder for coding the audio data outputted from the time axis compressor/expander 5 may be provided in the preceding stage of the ring memory 6, and an audio decoder 12 for decoding the coded data read out of the ring memory 6 may be provided in the succeeding stage of the ring memory 6, as in FIG. 3.

Although in the above-mentioned first embodiment and the second embodiment, description was made of a case where an analog audio signal is fed from the VTR 20 or the audio reproducer 30, the present invention is also applicable to a case where digital audio data is fed from the VTR 20 or the audio reproducer 30. In this case, the digital audio data fed from the VTR 20 or the audio reproducer 30 may be written into the frame memory 2 at a writing speed corresponding to the reproduction speed magnification, and the audio data may be read out of the ring memory at the same speed as the speed at which the audio data is written into the frame memory 2 at the time of reproduction at the standard reproduction speed.

[3] Description of Third Embodiment

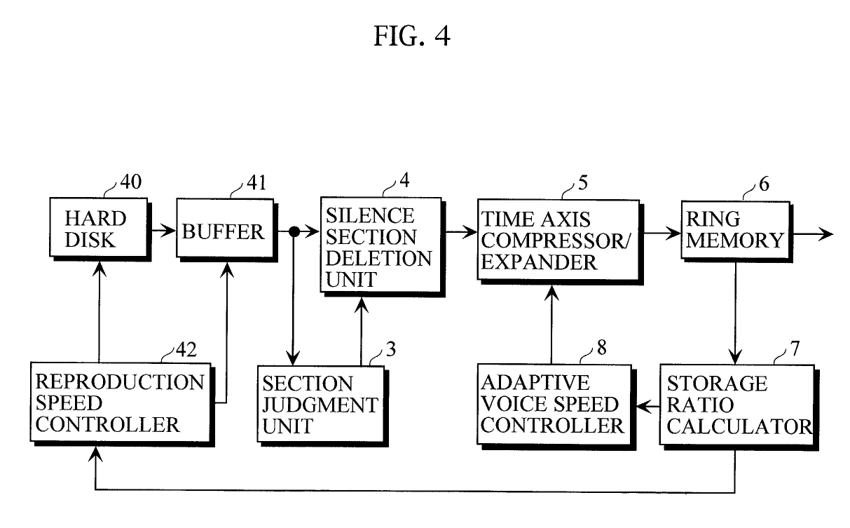

FIG. 4 illustrates an example in which a voice speed converting apparatus is applied to a reproduction circuit in a hard disk recorder. In FIG. 4, the same units as those shown in FIG. 1 are assigned the same reference numerals and hence, the description thereof is not repeated.

In FIG. 4, reference numeral 40 denotes a hard disk (HD) provided in the hard disk recorder and storing audio data. Reference numeral 41 denotes a buffer temporarily storing the audio data read out of the hard disk 40 at the time of reproduction. Reference numeral 42 denotes a reproduction speed controller for controlling the speed at which the audio data is outputted from the buffer 41.

In FIG. 4, an audio recording circuit for storing the audio data in the hard disk 40 is omitted. In the hard disk recorder, examples of a reproduction mode are a fast listening mode for performing reproduction in a short time while preventing the voice speed of an output voice from being increased and preventing audio information from being missing and a slow listening mode for reducing the voice speed to perform reproduction. Description is now made of operations at the time of each of the reproduction modes.

[3-1] Description of Operations at the Time of Fast Listening Mode

Table 3 shows the relationship between the storage ratio and the compression ratio and the relationship between the storage ratio and the magnification of the speed at which audio data is outputted from the buffer 41 (the reproduction speed magnification) at the time of the fast listening mode.

TABLE 3

| Storage ratio | | Output speed |
|---|---|---|
| (memory | Compression | magnification |
| remaining ratio) | ratio | from buffer |
| 0˜20% (80˜ | 1 | 2 |
| 100) | | |
| 20˜40% (60˜80) | 1.2 | 2 |
| 40˜60% (40˜60) | 1.4 | 2 |
| 60˜80% (20˜40) | 1.4 | 1.8 |
| 80˜95% (5˜20) | 1.4 | 1.6 |
| 95˜100% (0˜5) | 1.4 | 1.4 |

An adaptive voice speed controller 8 comprises a storage ratio/compression ratio table for the fast listening mode storing the relationship between the storage ratio and the compression ratio in Table 3. The reproduction speed controller 42 comprises a storage ratio/reproduction speed magnification table for the fast listening mode storing the relationship between the storage ratio and the reproduction speed magnification in Table 3.

The adaptive voice speed controller 8 reads out, when the storage ratio is fed from a storage ratio calculator 7, the compression ratio corresponding to the storage ratio fed from the storage ratio calculator 7 on the basis of the storage ratio/compression ratio table for the fast listening mode.

The reproduction speed controller 42 reads out, when the storage ratio is fed from the storage ratio calculator 7, the reproduction speed magnification corresponding to the storage ratio fed from the storage ratio calculator 7 on the basis of the storage ratio/reproduction speed magnification table for the fast listening mode, to carry out control such that the speed at which the audio data is outputted from the buffer 41 corresponds to the reproduction speed magnification. The speed at which the audio data is read out of the hard disk 40 is much higher, as compared with the speed at which the audio data is outputted from the buffer 41, thereby preventing the buffer 41 from being emptied.

(1) When the storage ratio is 0 to 20% (not less than 0 and less than 20%)

When the storage ratio is 0 to 20%, the compression ratio is set to 1, and the reproduction speed magnification is set to 2. In this case, the reproduction speed controller 42 outputs the audio data from the buffer 41 at a speed corresponding to twice the standard reproduction speed.

Out of the audio data outputted from the buffer 41, the audio data corresponding to a silence section are deleted by a silence section deletion unit 4, and the audio data other than the deleted audio data are then stored in a ring memory 6 without being subjected to time axis compression/expansion processing in a time axis compressor/expander 5. The audio data stored in the ring memory 6 are read out at the standard reproduction speed, and are outputted. Consequently, the voice speed of an output voice is equal to that at the time of reproduction at the standard reproduction speed.

Since the rate of data transfer in writing to the ring memory 6 is higher than the rate of data transfer in reading from the ring memory 6, the amount of storage of the audio data, which have not been read out yet, in the ring memory 6 is increased. The smaller the number of the audio data corresponding to the silence section out of the input audio data is, the higher the speed at which the amount of storage of the audio data which have not been read out yet is increased becomes.

(2) When the storage ratio is 20 to 40%

When the storage ratio is 20 to 40%, the compression ratio is set to 1.2. However, the reproduction speed magnification remains at 2. In this case, the time axis compressor/expander 5 subjects the input audio data to time axis compression processing such that the ratio of the time length P of an input signal to the time length Q of an output signal is 1.2:1. As a result, the voice speed of an output voice is slightly higher than that at the time of reproduction at the standard reproduction speed. On the other hand, the number of the audio data corresponding to the voice section which are inputted to the ring memory 6 is reduced. Accordingly, the ratio of the number of data written into the ring memory 6 to the number of data read out of the ring memory 6 can be made lower, as compared with that in the above-mentioned case (1)

(3) When the storage ratio is 40 to 60%

When the storage ratio is 40 to 60%, the compression ratio is set to 1.4. However, the reproduction speed magnification remains at 2. In this case, the time axis compressor/expander 5 subjects the input audio data to time axis compression processing such that the ratio of the time length P of an input signal to the time length Q of an output signal is 1.4:1. As a result, the voice speed of an output voice is further made higher, as compared with that in the above-mentioned case (2). On the other hand, the number of the audio data corresponding to the voice section which are inputted to the ring memory 6 is further made smaller, as compared with that in the above-mentioned case (2). Accordingly, the ratio of the number of data written into the ring memory 6 to the number of data read out of the ring memory 6 can be made lower, as compared with that in the above-mentioned case (2).

(4) When the storage ratio is 60 to 80%

When the storage ratio is 60 to 80%, the compression ratio is set to 1.4, and the reproduction speed magnification is set to 1.8. In this case, the reproduction speed controller 42 outputs the audio data from the buffer 41 at a speed corresponding to 1.8 times the standard reproduction speed. Further, the time axis compressor/expander 5 subjects the input audio data to time axis compression processing such that the ratio of the time length P of an input signal to the time length Q of an output signal is 1.4:1.

Since the reproduction speed magnification is set to 1.8, the rate of data transfer in writing to the ring memory 6 is made lower, as compared with that in the above-mentioned case (3). Accordingly, the ratio of the number of data written into the ring memory 6 to the number of data read out of the ring memory 6 can be made lower, as compared with that in the above-mentioned case (3). Further, the reproduction speed magnification is made lower, as compared with that in the above-mentioned case (3) Accordingly, the voice speed of an output voice is not much higher, as compared with that in a case where only the compression ratio is increased. That is, the voice speed can be made high in a range in which listening is easy.

(5) When the storage ratio is 80 to 95%

When the storage ratio is 80 to 95%, the compression ratio is set to 1.4, and the reproduction speed magnification is set to 1.6. In this case, the reproduction speed controller 42 outputs the audio data from the buffer 41 at a speed corresponding to 1.6 times the standard reproduction speed. Further, the time axis compressor/expander 5 subjects the input audio data to time axis compression processing such that the ratio of the time length P of an input signal to the time length Q of an output signal is 1.6:1.

Since the reproduction speed magnification is set to 1.6, the rate of data transfer in writing to the ring memory 6 is made lower, as compared with that in the above-mentioned case (4). Accordingly, the ratio of the number of data written into the ring memory 6 to the number of data read out of the ring memory 6 can be made lower, as compared with that in the above-mentioned case (4). Further, the reproduction speed magnification is made lower, as compared with that in the above-mentioned case (4). Accordingly, the voice speed of an output voice is not much higher, as compared with that in a case where only the compression ratio is increased. That is, the voice speed can be made high in a range in which listening is easy.

(6) When the storage ratio is 95 to 100%

When the storage ratio is 95 to 100%, the compression ratio is set to 1.4, and the reproduction speed magnification is set to 1.4. In this case, the reproduction speed controller 42 outputs the audio data from the buffer 41 at a speed corresponding to 1.4 times the standard reproduction speed. Further, the time axis compressor/expander 5 subjects the input audio data to time axis compression processing such that the ratio of the time length P of an input signal to the time length Q of an output signal is 1.4:1.

Since the reproduction speed magnification is set to 1.4, the rate of data transfer in writing to the ring memory 6 is made lower, as compared with that in the above-mentioned case (5). Accordingly, the ratio of the number of data written into the ring memory 6 to the number of data read out of the ring memory 6 can be made lower, as compared with that in the above-mentioned case (5). Further, the reproduction speed magnification is made lower, as compared with that in the above-mentioned case (5). Accordingly, the voice speed of an output voice is not much higher, as compared with that in a case where only the compression ratio is increased. That is, the voice speed can be made high in a range in which listening is easy.

[3-2] Description of Operations at the Time of Slow Listening Mode

Table 4 shows the relationship between the storage ratio and the compression ratio and the relationship between the storage ratio and the magnification of the speed at which audio data is outputted from the buffer 41 (the reproduction speed magnification) at the time of the slow listening mode.

TABLE 4

| Storage ratio | | Output speed |
|---|---|---|
| (memory | Compression | magnification |
| remaining ratio) | ratio | from buffer |
| 0˜25% (75˜100) | 0.7 | 1 |
| 25˜50% (50˜75) | 0.8 | 1 |
| 50˜75% (25˜50) | 0.9 | 0.9 |
| 75˜100% (0˜25) | 1 | 0.8 |

The adaptive voice speed controller 8 comprises a storage ratio/compression ratio table for the slow listening mode storing the relationship between the storage ratio and the compression ratio in Table 4. The reproduction speed controller 42 comprises a storage ratio/reproduction speed magnification table for the slow listening mode storing the relationship between the storage ratio and the reproduction speed magnification in Table 4.

The adaptive voice speed controller 8 reads out, when the storage ratio is fed from the storage ratio calculator 7, the compression ratio corresponding to the storage ratio fed from the storage ratio calculator 7 on the basis of the storage ratio/compression ratio table for the slow listening mode, and sets the read compression ratio in the time axis compressor/expander 5.

The reproduction speed controller 42 reads out, when the storage ratio is fed from the storage ratio calculator 7, the reproduction speed magnification corresponding to the storage ratio fed form the storage ratio calculator 7 on the basis of the storage ratio/reproduction speed magnification table for the slow listening mode, to carry out control such that the speed at which the audio data is outputted from the buffer 41 corresponds to the reproduction speed magnification.

(1) When the storage ratio is 0 to 25%

When the storage ratio is 0 to 25%, the compression ratio is set to 0.7, and the reproduction speed magnification is set to 1. In this case, the reproduction speed controller 42 outputs the audio data from the buffer 41 at the standard reproduction speed.

Out of the audio data outputted from the buffer 41, the audio data corresponding to a silence section are deleted by the silence section deletion unit 4, and the audio data other than the deleted audio data are then fed to the time axis compressor/expander 5. The time axis compressor/expander 5 subjects the input data (the audio data corresponding to a voice section) to time axis expansion processing such that the ratio of the time length P of an input signal to the time length Q of an output signal is 0.7:1.

The audio data which has been subjected to the time axis expansion processing by the time axis compressor/expander 5 are stored in the ring memory 6. The audio data stored in the ring memory 6 are read out at the standard reproduction speed, and are outputted.

The audio data corresponding to the voice section are expanded on the time axis, and are written into the ring memory 6. Accordingly, the voice speed of an output voice is lower than that at the time of reproduction at the standard reproduction speed. However, the smaller the number of the audio data corresponding to the silence section is, the larger the amount of storage of the audio data, which have not been read out yet, in the ring memory 6 becomes.

(2) When the storage ratio is 25 to 50%

When the storage ratio is 25 to 50%, the compression ratio is set to 0.8. However, the reproduction speed magnification remains at 1. In this case, the time axis compressor/expander 5 subjects the input audio data to time axis expansion processing such that the ratio of the time length P of an input signal to the time length Q of an output signal is 0.8:1. As a result, the voice speed of an output voice is lower than that at the time of reproduction at the standard reproduction speed, but is slightly higher, as compared with that in the above-mentioned case (1). However, the number of the audio data corresponding to the voice section which are inputted to the ring memory 6 is made lower, as compared with that in the above-mentioned case (1). Accordingly, the ratio of the number of data written into the ring memory 6 to the number of data read out of the ring memory 6 can be made lower, as compared with that in the above-mentioned case (1)

(3) When the storage ratio is 50 to 75%

When the storage ratio is 50 to 75%, the compression ratio is set to 0.9, and the reproduction speed magnification is set to 0.9. In this case, the reproduction speed controller 42 outputs the audio data from the buffer 41 at a speed corresponding to 0.9 times the standard reproduction speed. Further, the time axis compressor/expander 5 subjects the input audio data to time axis expansion processing such that the ratio of the number of data P inputted per unit time to the number of data Q outputted per unit time is 0.9:1.

Since the compression ratio on the time axis is made higher, as compared than that in the above-mentioned case (2), and the reproduction speed magnification is made lower, as compared with that in the above-mentioned case (2), the ratio of the number of data written into the ring memory 6 to the number of data read out of the ring memory 6 can be made lower, as compared with that in the above-mentioned case (2). However, the reproduction speed magnification is made lower, as compared with that in the above-mentioned case (2). Accordingly, the voice speed of an output voice is not made higher, as compared with that in a case where only the compression ratio is increased.

(4) When the storage ratio is 75 to 100%

When the storage ratio is 75 to 100%, the compression ratio is set to 1.0, and the reproduction speed magnification is set to 0.8. The reproduction speed controller 42 outputs the audio data from the buffer 41 at a speed corresponding to 0.8 times the standard reproduction speed. Further, the time axis compressor/expander 5 does not perform time axis expansion processing.

Since the compression ratio on the time axis is made lower, as compared with that in the above-mentioned case (3), and the reproduction speed magnification is made lower, as compared with that in the above-mentioned case (3), the ratio of the number of data written into the ring memory 6 to the number of data read out of the ring memory 6 can be made lower, as compared with that in the above-mentioned case (3). However, the reproduction speed magnification is made lower, as compared with that in the above-mentioned case (3. Accordingly, the voice speed of an output voice is not made higher, as compared with that in a case where only the compression ratio is increased.

Although the present invention has been described and illustrated in detail, it is clearly understood that the same is by way of illustration and example only and is not to be taken by way of limitation, the spirit and scope of the present invention being limited only by the terms of the appended claims.

What is claimed

1. In a voice speed converting apparatus comprising voice speed conversion processing means for subjecting an input audio signal inputted from an audio reproducer to voice speed conversion processing, an audio data storing memory into which an output of the voice speed conversion processing means is to be written, and means for reading out audio data from the audio data storing memory, a voice speed converting apparatus comprising:
calculation means for calculating the storage ratio of the audio data, which have not been read out yet, in the audio data storing memory; and
control means for controlling the reproduction speed of the audio reproducer depending on the storage ratio of the audio data, which have not been read out yet, in the audio data storing memory.

2. The voice speed converting apparatus according to claim 1, wherein
the voice speed conversion processing means comprises
section judgment means for judging whether the input audio signal corresponds to a voice section or a silence section;
deletion processing means for deleting the input audio signal which is judged to correspond to the silence section; and
time axis compression/expansion processing means for subjecting the input audio signal which is judged to correspond to the voice section to time axis compression/expansion processing at a compression ratio corresponding to the storage ratio of the audio data, which have not been read out yet, in the audio data storing memory.

3. The voice speed converting apparatus according to claim 1, wherein
the audio reproducer is a VTR.

4. The voice speed converting apparatus according to claim 2, wherein
the audio reproducer is a VTR.

5. The voice speed converting apparatus according to claim 1, wherein
the audio reproducer is a hard disk recorder.

6. The voice speed converting apparatus according to claim 2, wherein
the audio reproducer is a hard disk recorder.

7. In a voice speed converting apparatus comprising analog-to-digital conversion means for sampling an analog audio signal inputted from an audio reproducer at a sampling frequency corresponding to the set reproduction speed magnification, a frame memory into which the audio data outputted from the analog-to-digital conversion means is to be inputted, voice speed conversion processing means for subjecting, every time a required number of audio data are inputted to the frame memory, the audio data to voice speed conversion processing, an audio data storing memory into which an output of the voice speed conversion processing means is to be written, and means for reading out the audio data from the audio data storing memory, a voice speed converting apparatus comprising:
calculation means for calculating the storage ratio of the audio data, which have not been read out yet, in the audio data storing memory; and
control means for controlling the reproduction speed of the audio reproducer depending on the storage ratio of the audio data, which have not been read out yet, in the audio data storing memory.

8. The voice speed converting apparatus according to claim 7, wherein
the voice speed conversion processing means comprises
section judgment means for judging whether an input voice composed of a required number of audio data inputted to the frame memory corresponds to a voice section or a silence section;
deletion processing means for deleting the audio data which is judged to correspond to the silence section; and
time axis compression/expansion processing means for subjecting the audio data which is judged to correspond to the voice section to time axis compression/expansion processing at a compression ratio corresponding to the storage ratio of the audio data, which have not been read out yet, in the audio data storing memory.

9. In a voice speed converting apparatus comprising a frame memory into which a digital audio signal inputted from an audio reproducer is to be written at a speed corresponding to the set reproduction speed magnification, voice speed conversion processing means for subjecting, every time a required number of audio data are inputted to the frame memory, the audio data to voice speed conversion processing, an audio data storing memory into which an output of the voice speed conversion processing means is to be written, and means for reading out the audio data from the audio data storing memory, a voice speed converting apparatus comprising:
calculation means for calculating the storage ratio of the audio data, which have not been read out yet, in the audio data storing memory; and
control means for controlling the reproduction speed of the audio reproducer depending on the storage ratio of the audio data, which have not been read out yet, in the audio data storing memory.

10. The voice speed converting apparatus according to claim 9, wherein
the voice speed conversion processing means comprises
section judgment means for judging whether an input voice composed of a required number of audio data inputted to the frame memory corresponds to a voice section or a silence section;
deletion processing means for deleting the audio data which is judged to correspond to the silence section; and
time axis compression/expansion processing means for subjecting the audio data which is judged to correspond to the voice section to time axis compression/expansion processing at a compression ratio corresponding to the storage ratio of the audio data, which have not been read out yet, in the audio data storing memory.
